(19) United States
(12) Patent Application Publication
(10) Pub. No.: US 2025/0132435 A1
(43) Pub. Date: Apr. 24, 2025

(54) CASE, BATTERY MODULE COMPRISING CASE, AND MANUFACTURING METHOD OF CASE

(71) Applicant: SK On Co., Ltd., Seoul (KR)

(72) Inventors: Jin Woo SON, Daejeon (KR); Dong Min KIM, Daejeon (KR); Chae Won NA, Daejeon (KR); Su A KIM, Daejeon (KR)

(21) Appl. No.: 18/914,266

(22) Filed: Oct. 14, 2024

(30) Foreign Application Priority Data
Oct. 23, 2023 (KR) 10-2023-0141983

(51) Int. Cl. H01M 50/233; B21D 22/02; H01M 50/211; H01M 50/224

(52) U.S. Cl. CPC H01M 50/233; B21D 22/02; H01M 50/211; H01M 50/224

(57) ABSTRACT

A battery module includes a cell assembly including a plurality of battery cells; and a case including a main plate supporting the cell assembly and a side wall extending from the main plate in a first direction. The main plate includes a central portion and an end region extending from the central portion. At least a portion of the central portion protrudes further in the first direction, than at least a portion of the end region, or is coplanar with the at least a portion of the end region.

### CROSS-REFERENCE TO RELATED APPLICATION(S)

This patent document claims the priority and benefits of Korean Patent Application No. 10-2023-0141983 filed on Oct. 23, 2023, the disclosure of which is incorporated herein by reference in its entirety.

### TECHNICAL FIELD

The disclosure and implementations disclosed in this patent document generally relate to a case, a battery module including the case, and a method of manufacturing the case.

### BACKGROUND

Unlike primary batteries, secondary batteries may be charged and discharged, and may thus be applied to devices within various fields such as digital cameras, mobile phones, laptops, hybrid vehicles, electric vehicles, and energy storage systems (ESS). The secondary battery may be a lithium ion battery, a nickel-cadmium battery, a nickel-metal hydride battery, or a nickel-hydrogen battery.

Secondary batteries may be manufactured as flexible pouch-type battery cells or rigid prismatic or cylindrical can-type battery cells. A plurality of battery cells may be formed as a stacked cell assembly.

A cell assembly may be disposed in a case to form a battery module, and a plurality of battery modules may be disposed in a pack housing to form a battery pack.

### SUMMARY

The disclosure of this patent document may be implemented in some embodiments to provide a battery module including a cell assembly and a case supporting the cell assembly. The case may be deformed due to load caused by components of the battery module. For example, due to load of the cell assembly and load of a busbar assembly, a central portion of the case may sag further in a downward direction, based on the battery module, than an end region of the case. Due to deformation occurring in the battery module, assembly difficulty may increase when the battery module is assembled into a power storage device (e.g., battery pack, electric vehicle, and energy storage system).

According to an aspect of the disclosure of this patent document, a battery module with reduced deformation (e.g., sagging in a downward direction) of the battery module may be provided.

A case, a battery module including the case, and a method of manufacturing the case, according to the disclosure of this patent document, may be widely applied in green technology fields such as electric vehicles, battery charging stations, solar power generation and wind power generation using other batteries, or the like. In addition, a case, a battery module including the case, and a method of manufacturing the case, according to the disclosure of this patent document, may be used in eco-friendly electric vehicles, hybrid vehicles, or the like, to prevent climate change by suppressing air pollution and greenhouse gas emissions.

In some embodiments of the disclosure of this patent document, a battery module includes a cell assembly including a plurality of battery cells; and a case including a main plate supporting the cell assembly and a side wall extending from the main plate in a first direction. The main plate may include a central portion and an end region extending from the central portion. At least a portion of the central portion may protrude further than at least a portion of the end region in the first direction, or may be coplanar with the at least a portion of the end region.

According to an embodiment, before the case is assembled with the cell assembly, the central portion may be formed to protrude further than the end region in the first direction.

According to an embodiment, a difference in heights between the central portion and the end region may be within 0.5 mm.

According to an embodiment, the case may include stainless steel or aluminum.

According to an embodiment, the battery module may further include a busbar assembly including a busbar connected to electrode tabs of the plurality of battery cells, and a busbar frame supporting the busbar; a cover disposed on one side of the cell assembly and connected to the side wall; an end plate connected to the case and surrounding at least a portion of the cell assembly; and an insulating cover located on at least a portion of the busbar assembly and the side wall.

In some embodiments of the disclosure of this patent document, a case of the disclosure of this patent document includes a main plate configured to support a cell assembly; and a side wall extending from the main plate in a first direction. The main plate may include a central portion and an end region extending from the central portion. The central portion may be formed to protrude further than the end region in the first direction.

According to an embodiment, a height of the central portion in the first direction may be more than or less than a height of the end region by 0.1 mm to 0.7 mm.

According to an embodiment, the case may include at least one of stainless steel or aluminum.

In some embodiments of the disclosure of this patent document, a method for manufacturing a battery case, includes a first pressing process of forming a case including a main plate and a side wall extending from the main plate in a first direction; and a second pressing process of pressing a central portion of the main plate using a pressing mold including a protrusion.

According to an embodiment, the pressing mold may include a first mold including a first protrusion configured to contact the central portion, and a second mold configured to be located in an opposite direction of the first mold, based on the main plate.

According to an embodiment, the second mold may include a second protrusion configured to contact the central portion.

According to an embodiment, the first protrusion may provide an external force to a first surface of the main plate, and the second protrusion may provide an external force to a second surface of the main plate, opposite to the first surface.

According to an embodiment, the protrusion may include polyurethane.

According to an embodiment, the case may include a side wall extending from the main plate in the first direction. The main plate may include an end region extending from the central portion. The second pressing process may be configured to deform the main plate such that a height of the central portion protrudes further in the first direction, than a height of the end region.

According to an embodiment, the height of the central portion deformed by the second pressing process may be more than or less than a height of the end region by 0.1 mm to 0.7 mm.

### BRIEF DESCRIPTION OF DRAWINGS

Certain aspects, features, and advantages of the disclosure of this patent document may be illustrated by the following detailed description with reference to the accompanying drawings.

FIG. 1 is a perspective view of a battery cell according to an embodiment.

FIG. 2 is a perspective view of a battery module according to an embodiment.

FIG. 3 is an exploded perspective view of a battery module according to an embodiment.

FIG. 4 is a top view of a case according to an embodiment.

FIG. 5 is a flowchart of a method for manufacturing a case according to an embodiment.

FIGS. 6A and 6B are views of a device for manufacturing a case according to an embodiment.

FIGS. 7A and 7B are views of a device d for manufacturing a case according to another embodiment.

FIGS. 8A and 8B are graphs illustrating flatness of a case according to an embodiment.

FIG. 9 is a graph illustrating flatness of a case according to a first comparative example.

FIGS. 10A, 10B, and 10C are graphs illustrating flatness of a case according to a second comparative example.

FIGS. 11A and 11B are graphs illustrating flatness of a case mounted on a battery module according to an embodiment.

FIG. 12 is a graph illustrating flatness of a case mounted on a battery module according to a first comparative example.

FIG. 13 is an exploded perspective view of a battery pack according to an embodiment.

### DETAILED DESCRIPTION

Features of the disclosure of this patent document disclosed in this patent document may be described by example embodiments with reference to the accompanying drawings.

Hereinafter, the disclosure of this patent document will be described in detail with reference to the attached drawings. However, this is merely illustrative and the disclosure of this patent document is not limited to the specific embodiments described by way of example.

Terms or words used in the specification and claims described below may not be to be construed as being limited to their ordinary or dictionary meanings. The inventor will interpret the meaning and concept consistent with the technical idea of the disclosure of this patent document based on the principle that the concept of the term is appropriately defined in order to explain the disclosure of this patent document in the best manner possible.

Accordingly, the embodiments described in this specification and the configurations illustrated in the drawings may be only the most preferred embodiments of the disclosure of this patent document, and do not represent the entire technical idea of the disclosure of this patent document, and it will be appreciated that there are various equivalents and variations may be substituted therefor at the time of filing the disclosure of this patent document.

Detailed descriptions of well-known functions and configurations that may obscure the gist of the disclosure of this patent document may be omitted. In the attached drawings, some components may be exaggerated, omitted, or schematically illustrated, and a size of each of the components does not entirely reflect an actual size thereof.

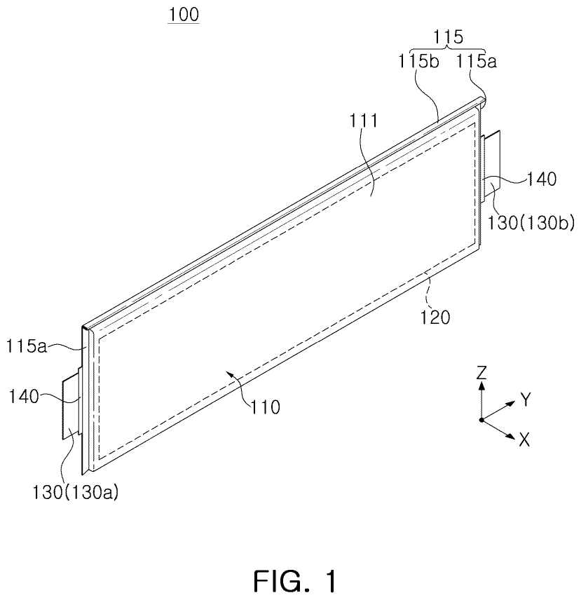

FIG. 1 is a perspective view of a battery cell according to an embodiment.

Referring to FIG. 1, a battery cell 100 may include a pouch 110, an electrode assembly 120, and an electrode tab 130. The battery cell 100 may be a secondary battery. For example, the battery cell 100 may be a lithium ion battery, but the disclosure of this patent document is not limited thereto. For example, the battery cell 100 may be a nickel-cadmium battery, a nickel-metal hydride battery, or a nickel-hydrogen battery, capable of being charged and discharged.

The pouch 110 may form at least a portion of an exterior of the battery cell 100. The pouch 110 may include an electrode accommodating portion 111 accommodating the electrode assembly 120, and a sealing portion 115 sealing at least a portion of a circumference of the electrode accommodating portion 111. The electrode accommodating portion 111 may provide a space accommodating the electrode assembly 120 and an electrolyte solution.

The sealing portion 115 may be formed by joining at least a portion of a circumference of the pouch 110. The sealing portion 115 may be formed in a flange shape extending outward from the electrode accommodating portion 111 formed in a container shape, and may be disposed along at least a portion of an external boundary of the electrode accommodating portion 111. In an embodiment, the sealing portion 115 may include a first sealing portion 115a in which the electrode tab 130 is located, and a second sealing portion 115b in which the electrode tab 130 is not located. A portion of the electrode tab 130 may be drawn out or exposed outside of the pouch 110. In a position in which the electrode tab 130 is drawn out, to increase a sealing degree of the first sealing portion 115a and at the same time ensure an electrical insulation state, the electrode tab 130 may be covered by an insulating film 140. The insulating film 140 may be formed of a film material having a thickness, smaller than a thickness of the electrode tab 130, and may be attached to both surfaces of the electrode tab 130.

In an embodiment, the electrode tabs 130 may be arranged on both sides of the battery cell 100 in a longitudinal direction (Y-axis direction) to face in opposite directions. For example, the electrode tab 130 may include a positive lead 130a of a first polarity (e.g., positive electrode) facing one side of the battery cell 100 in the longitudinal direction, and a negative lead 130b of a second polarity (e.g., negative electrode) facing the other side of the battery cell 100 in the longitudinal direction. In the embodiment illustrated in FIG. 1, the sealing portion 115 may include two first sealing portions 115a on which the electrode tab 130 is disposed, and one second sealing portion 115b on which the electrode tab 130 is not disposed. In an embodiment, the electrode tab 130 may be referred to as an electrode lead.

A direction in which the electrode tab 130 is located may be selectively designed. In an embodiment (e.g., FIG. 1), the electrode tab 130 may include the first electrode lead 130a, and the second electrode lead 130b located in a direction, opposite to the first electrode lead 130a, based on the electrode assembly 120. In FIG. 1, the electrode tabs 130 are illustrated to face opposite directions on both sides of the battery cell 100 in the longitudinal direction (e.g., Y-axis direction), but structures of the electrode tabs 130 are not limited thereto. For example, the two electrode tabs 130 may be arranged substantially in parallel in the longitudinal direction (e.g., Y-axis direction) of the battery cell 100.

The pouch 110 is not limited to a structure in which the sealing portion 115 is formed on three surfaces by folding a single sheet of exterior material, as illustrated in FIG. 1.

In an embodiment of the disclosure of this patent document, at least a portion of the sealing portions 115 may be formed to be folded at least once. At least a portion of the sealing portion 115 may be folded to improve bonding reliability of the sealing portion 115 and minimize an area of the sealing portion 115. Among the sealing portions 115 according to an embodiment, the second sealing portion 115b on which the electrode tab 130 is not disposed may be folded twice and then fixed by an adhesive member (not illustrated). An angle at which the second sealing portion 115b is bent or the number of times which the second sealing portion 115b is bent may be changed. For example, in an embodiment (not illustrated), the second sealing portion 115b may be folded by 90° with respect to the first sealing portion 115a.

The electrode assembly 120 may include a cathode plate, an anode plate, and a separator. The separator may prevent contact between the cathode plate and the anode plate. Those skilled in the art will understand that the electrode assembly 120 may be manufactured using a variety of methods. According to example embodiments, an electrode assembly may be formed by repeatedly arranging a cathode, an anode, and a separator. In some embodiments, the electrode assembly may be of a winding type, a stacking type, a zigzag folding type, or a stack-folding type.

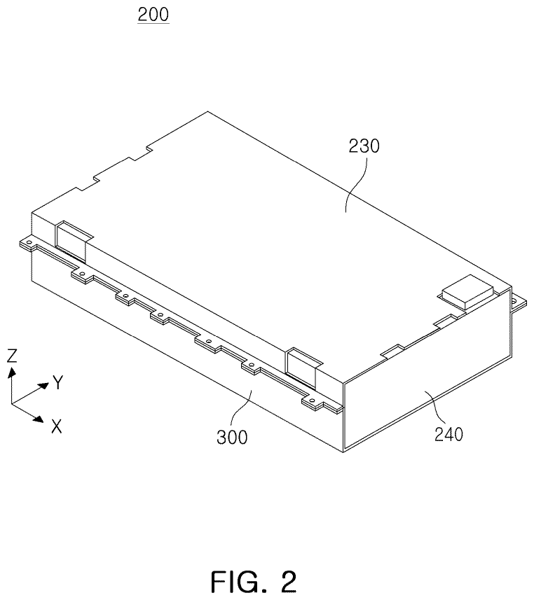

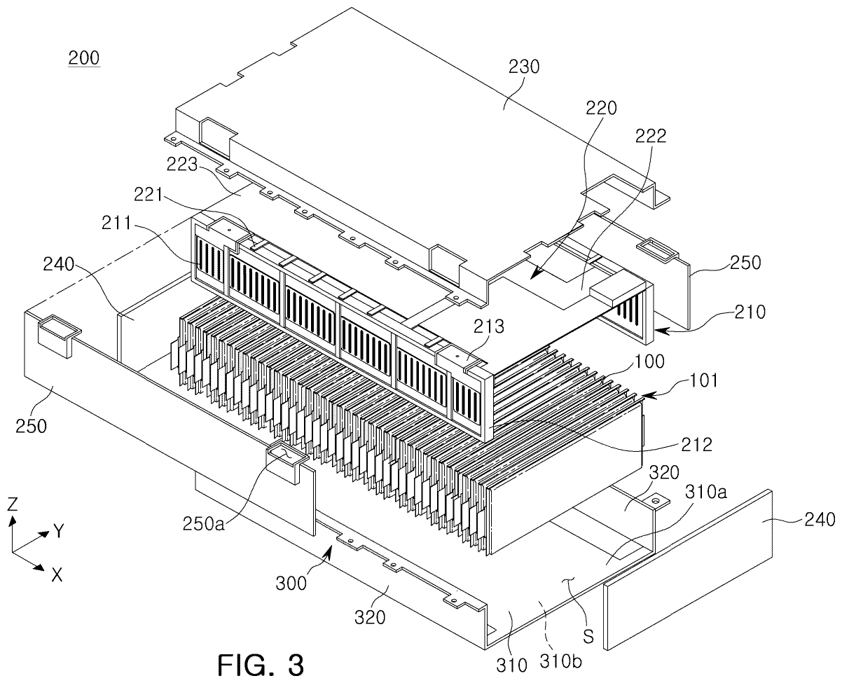

FIG. 2 is a perspective view of a battery module according to an embodiment. FIG. 3 is an exploded perspective view of a battery module according to an embodiment.

Referring to FIG. 2 and/or FIG. 3, a battery module 200 may include a cell assembly 101, a busbar assembly 210, a sensor assembly 220, a cover 230, an end plate 240, an insulating cover 250, and/or a case 300.

The cell assembly 101 may include a plurality of battery cells 100. Description of the battery cell 100 in FIG. 1 may be applied to a battery cell 100 in FIG. 3.

The cell assembly 101 may have a substantially hexahedral shape. In an embodiment, the cell assembly 101 may be referred to as a cell stack. In an embodiment, the cell assembly 101 may include the plurality of battery cells 100, connected using an adhesive tape. According to an embodiment, the cell assembly 101 may include a heat spread prevention member located between at least a portion of the plurality of battery cells 100.

The busbar assembly 210 may include a busbar 211 having electrical conductivity and electrically connected to an electrode tab 130 of the battery cell 100, and a busbar frame 212 supporting the busbar 211. The busbar frame 212 may be referred to as a support plate or a frame. The busbar frame 212 may be formed of an electrically insulating material (e.g., polymer). At least a portion of the busbar frame 212 may be disposed between the cell assembly 101 and the busbar 211, to support the busbar 211. The busbar frame 212 may include at least one fastening hole for receiving a coupling component (e.g., screw, rivet, and/or boss structure). The busbar frame 212 may be coupled to a portion of the case 300 (e.g., side wall 320) by the coupling component. In an embodiment, the busbar 211 may be referred to as an internal busbar.

The busbar assembly 210 may include at least one terminal busbar 213 for externally electrical connection. The electrode tab 130 of the battery cell 100 may be electrically connected to an outside of the battery module 200 through the busbar 211 and the terminal busbar 213. For example, the terminal busbar 213 may be electrically connected to the busbar 211, and current of the battery cell 100 may be transmitted to the outside of the battery module 200 through the busbar 211 and the terminal busbar 213. The terminal busbar 213 may be exposed to an outside of the case 300 through a hole 250a of the insulating cover 250. In an embodiment, the terminal busbar 213 may be referred to as a high voltage busbar.

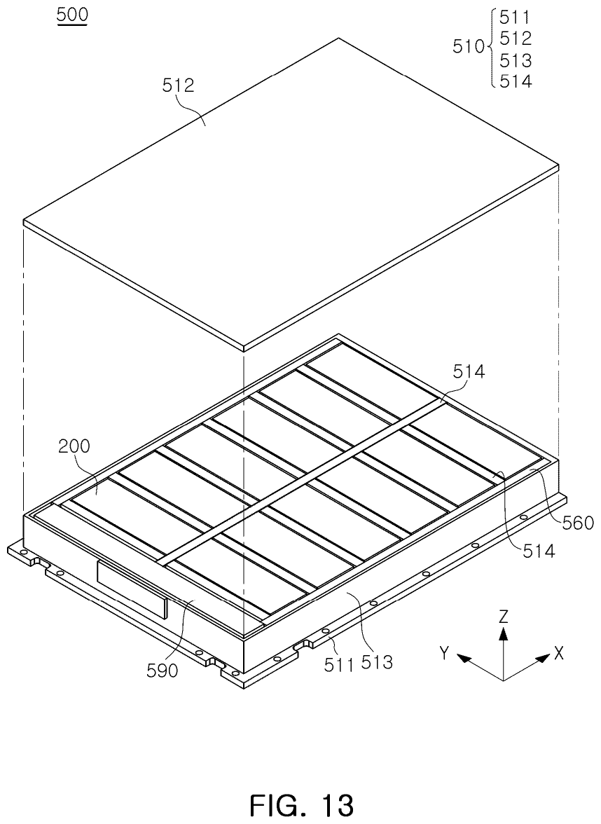

The sensor assembly 220 may include a sensor for sensing information about the battery module 200. For example, the sensor assembly 220 may include a temperature sensor (not illustrated) and at least one voltage sensing terminal 221 connected to the busbar 211. The sensor assembly 220 may include a flexible printed circuit board 222 connected to the voltage sensing terminal 221, and a circuit support member 223 supporting the flexible printed circuit board. The sensor assembly 220 may be connected to a battery control unit (e.g., battery control unit 590 of FIG. 13) located on the outside of the battery module 200.

The cover 230 may cover a portion (e.g., upper portion) of cell assembly 101. For example, the cover 230 may be disposed on one side of the cell assembly 101. The cover 230 may protect the cell assembly 101 from an external impact of the battery module 200. In an embodiment, the cover 230 may be referred to as an upper cover. The cover 230 may be connected to or assembled with the case 300, the end plate 240, and/or the insulating cover 250.

The end plate 240 may surround at least a portion of the cell assembly 101. In an embodiment, the end plate 240 may be connected to an end portion of a main plate 310 and an end portion of a side wall 320 in the longitudinal direction (e.g., X-axis direction). The end plate 240 may protect the cell assembly 101 from an external impact of the battery module 200. The end plate 240 may cover a portion of a side surface of the cell assembly 101.

The insulating cover 250 may prevent contact between at least a portion of the busbar assembly 210 (e.g., terminal busbar 213) and the case 300 (e.g., side wall 320). For example, at least a portion of the insulating cover 250 may be disposed between the terminal busbar 213 and the side wall 320. The insulating cover 250 may be formed of an insulating material (e.g., polymer), and may prevent current flow due to contact between the terminal busbar 213 and the side wall 320. In an embodiment, the insulating cover 250 may be disposed between the cell assembly 101 and the side wall 320.

The case 300 may form at least a portion of an exterior of the battery module 200 and may form an accommodation space S for accommodating the cell assembly 101 and/or the busbar assembly 210. The case 300 may protect the cell assembly 101 from an external impact. For example, the case 300 may include the main plate 310 supporting the cell assembly 101, and the side wall 320 extending from the main plate 310 in the first direction (e.g., +Z-direction). In an embodiment, the main plate 310 may be referred to as a lower plate. The cell assembly 101 may be mounted on the main plate 310. The main plate 310 may include a first surface 310a supporting the cell assembly 101, and a second surface 310b, opposite to the first surface 310a. The side wall 320 may cover at least a portion of a side surface of the cell assembly 101. For example, the side wall 320 may extend from both edges of the cell assembly 101 in the first direction. The side wall 320 may be formed integrally with the main plate 310. At least a portion of the accommodation space S may be surrounded by the case 300 (e.g., the main plate 310 and the side wall 320), the end plate 240, and the cover 230.

According to an embodiment, the case 300 may be formed of a material having high thermal conductivity, such as metal. For example, the case 300 may be formed of aluminum or stainless steel. The material of the case 300 is not limited thereto. According to another embodiment, the case 300 may be formed of polymer. The case 300 may be referred to as a battery case, a housing, a module housing, or a module case.

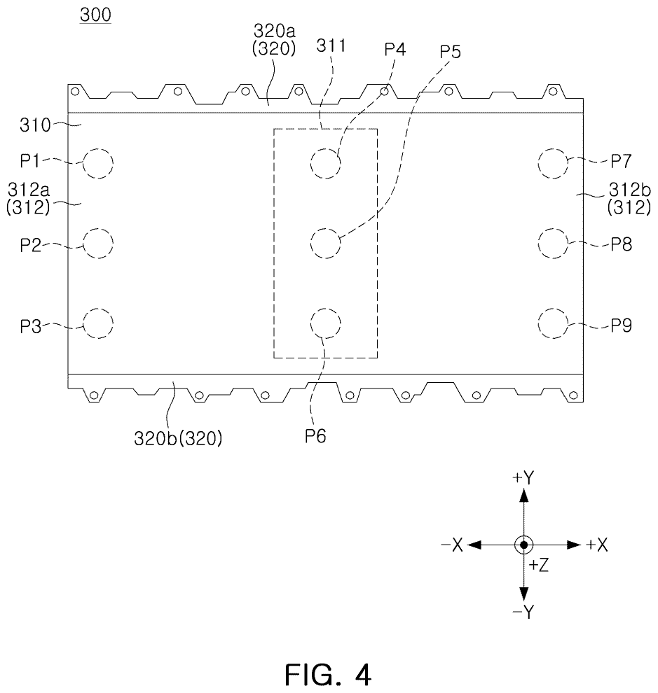

FIG. 4 is a top view of a case according to an embodiment.

Referring to FIG. 4, a case 300 may include a main plate 310 and a side wall 320. Description of the case 300 in FIGS. 2 and 3 may be applied to the case 300 in FIG. 4.

The main plate 310 may include a central portion 311 and an end region 312 extending from the central portion 311.

The central portion 311 may be located between a first end region 312a and a second end region 312b. For example, the central portion 311 may be a portion of the main plate 310 located between the side wall 320, the first end region 312a, and the second end region 312b. In an embodiment, the central portion 311 may be a portion of the main plate 310 including a fourth region P4, a fifth region P5, and a sixth region P6 of FIG. 4. In an embodiment, the fifth region P5 may be a portion of the main plate 310 including a center of gravity of the main plate 310.

In an embodiment, the fifth region P5 may be a portion of the main plate 310 located at half the length (e.g., distance in the X-axis direction) and half the width (e.g., distance in the Y-axis direction) of the main plate 310. The fourth region P4 may be a portion of the main plate 310 located in a fourth direction (+Y direction) from the fifth region P5. The fourth region P4 may be disposed closer to a first side wall 320a, as compared to the fifth region P5. The sixth region P6 may be a portion of the main plate 310 located in a fifth direction (−Y direction) from the fifth region P5. The sixth region P6 may be disposed closer to a second side wall 320b, as compared to the fifth region P5.

The end region 312 may include the first end region 312a facing in a third direction (e.g., −X direction) of the main plate 310, and the second end region 312b facing in a second direction (+X direction), opposite to the third direction (−X direction). The first end region 312a may include a first region P1, a second region P2, and a third region P3, located in the third direction (−X direction), corresponding to the fourth region P4, the fifth region P5, and the sixth region P6, respectively. The second end region 312b may include a seventh region P7, an eighth region P8, and a ninth region P9, located in the second direction (+X direction), corresponding to the fourth region P4, the fifth region P5, and the sixth region P6, respectively.

When the case 300 is assembled with a cell assembly (e.g., cell assembly 101 of FIG. 3), a portion of the main plate 310 may be bent due to load of a component (e.g., cell assembly 101 of FIG. 3) of a battery module (e.g., battery module 200 of FIG. 2). For example, the central portion 311 may sag, and the central portion 311 may be further located in a downward direction (e.g., −Z-direction), as compared to the end region 312. When the main plate 310 is deformed (e.g., bent), assemblability of the battery module 200 may be deteriorated.

Hereinafter, a case 300, a device for manufacturing the case 300, and a method for manufacturing the case, capable of preventing deformation of the main plate 310 will be described.

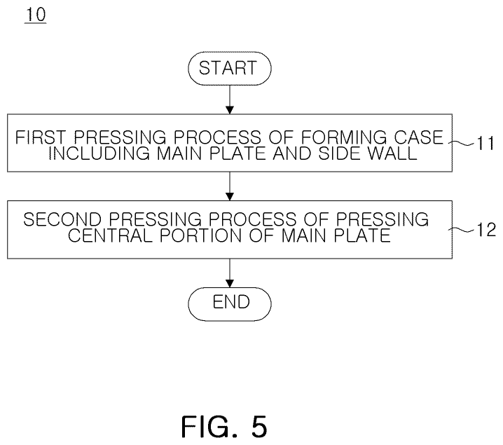

FIG. 5 is a flowchart of a method for manufacturing a case according to an embodiment.

Referring to FIG. 5, a method 10 for manufacturing a case may include a first pressing process 11 and a second pressing process 12. The method 10 may be a method for manufacturing the case 300 of FIGS. 2 to 4.

The first pressing process 11 may be a process of forming a case (e.g., temporary case or intermediate case) including a main plate 310 and a side wall 320 extending from the main plate 310, by using a mold (not illustrated). The case manufactured by the first pressing process 11 may be a case in which a central portion 311 of the main plate 310 is not pressed. For example, flatness of the case manufactured by the first pressing process 11 may be substantially uniform.

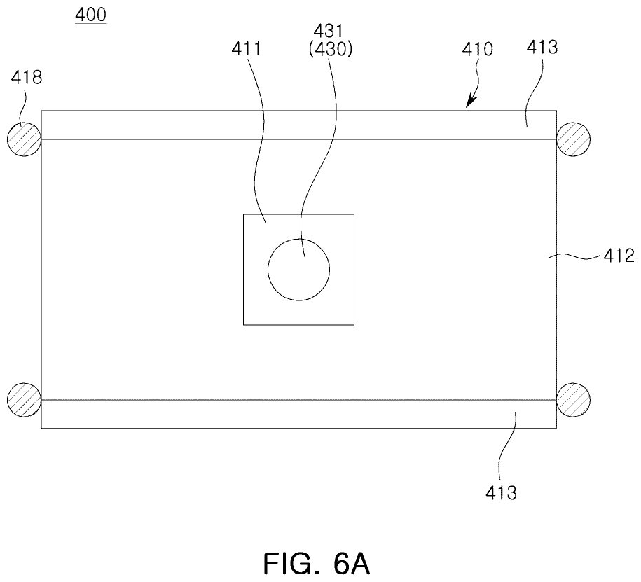

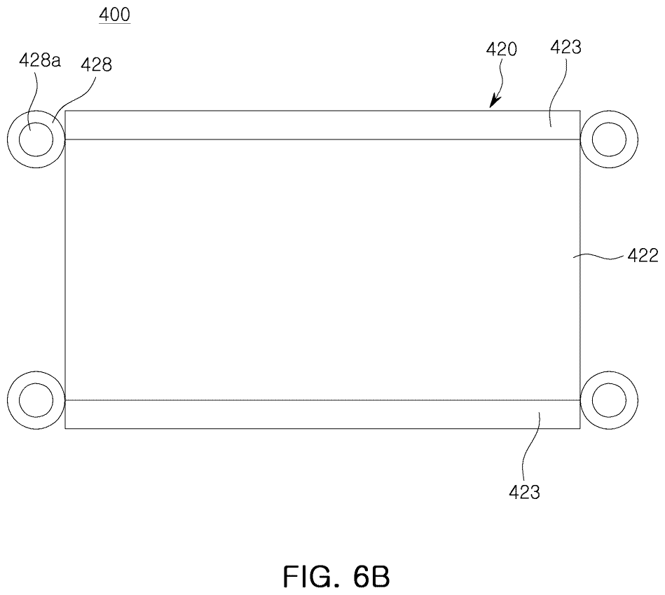

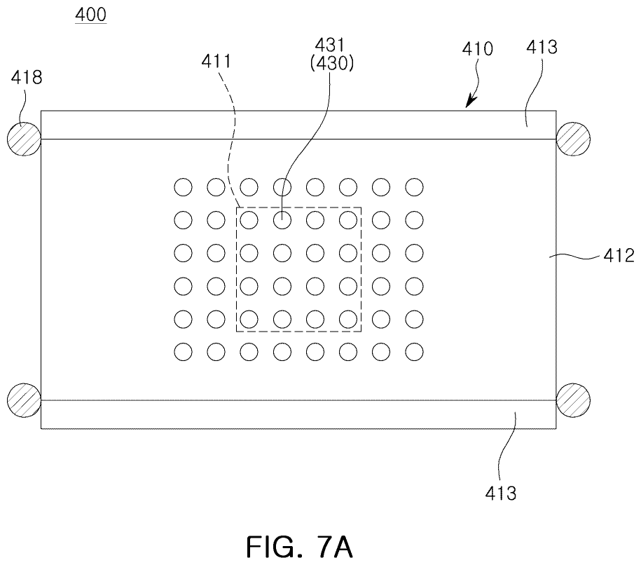

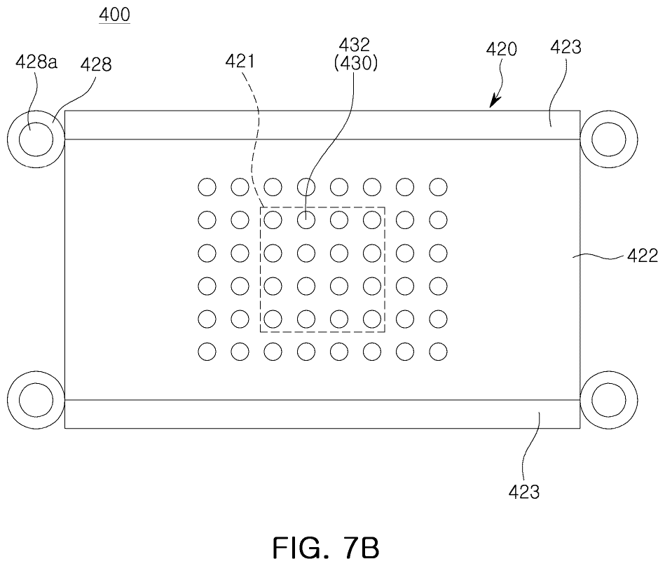

The second pressing process 12 may be a process of pressing a portion of the main plate 310 of the case 300, by using a mold (e.g., mold 400 in FIGS. 6A, 6B, 7A, and/or 7B). For example, the second pressing process 12 may press the central portion 311 of the main plate 310. The second pressing process 12 may be performed after the first pressing process 11. In an embodiment, the second pressing process 12 may be referred to as a re-strike process.

The second pressing process 12 may deform the main plate 310. For example, the second pressing process 12 may deform the main plate 310 such that the central portion 311 of the main plate 310 protrudes in the first direction (e.g., +Z-direction in FIG. 3). Flatness of the main plate 310 may be changed by the second pressing process 12. For example, the central portion 311 may protrude further in the first direction (+Z-direction), as compared to an end region 312.

FIGS. 6A and 6B are views of a device for manufacturing a case according to an embodiment. FIGS. 7A and 7B are views of a device for manufacturing a case according to another embodiment.

Referring to FIGS. 6A, 6B, 7A, and/or 7B along with FIG. 4, a pressing mold 400 may include a first mold 410 and a second mold 420. The pressing mold 400 may be used to manufacture the case 300 of FIG. 3. For example, the pressing mold 400 may be a mold for performing the second pressing process 12 of FIG. 5.

According to an embodiment, the pressing mold 400 may provide pressure or external force to a central portion 311 of a main plate 310. Flatness of the main plate 310 may be changed by the pressure or the external force provided from the pressing mold 400.

According to an embodiment, the pressing mold 400 may be formed to correspond to a shape of a case 300. For example, the pressing mold 400 may be formed to contact or be close to a surface of the main plate 310 and a surface of a side wall 320 in the case 300. According to an embodiment, the pressing mold 400 may provide external force on an inner surface (e.g., first surface 310a of FIG. 3) and a second surface (e.g., second surface 310b of FIG. 3) of the main plate 310.

The pressing mold 400 may include the first mold 410 and the second mold 420, with the case 300 located therebetween. For example, the second mold 420 may be located in an opposite direction of the first mold 410, based on the main plate 310. In an embodiment, the first mold 410 may be located above the case 300, and the second mold 420 may be located below the case 300. The first mold 410 may face a first surface 310a of the main plate 310, and the second mold 420 may face a second surface 310b of the main plate 310. In another embodiment, the first mold 410 may be located below the case 300, and the second mold 420 may be located above the case 300. The first mold 410 may face the second surface 310b of the main plate 310, and the second mold 420 may face the first surface 310a of the main plate 310.

According to an embodiment, the first mold 410 may include a first pressing region 412 that may face the main plate 310, and a protruding region 413 that may face at least a portion of the side wall 320. The second mold 420 may include a second pressing region 422 that may face the main plate 310, and a second protruding region 423 that may face at least a portion of the side wall 320.

According to an embodiment, the first mold 410 and the second mold 420 may be connected to each other using connection structures 418 and 428. For example, the first mold 410 may include at least one first connection structure 418, and the second mold 420 may include a second connection structure 428 for accommodating the first connection structure 418. The first connection structure 418 may have a pillar shape. The second connection structure 428 may have a cylindrical shape with a hole 428a formed to accommodate the first connection structure 418.

According to an embodiment, the pressing mold 400 may include a protrusion 430 for providing pressure or external force to the central portion 311 of the main plate 310. The protrusion 430 may be in contact with the central portion 311 of the main plate 310, and may change a shape of the central portion 311. For example, the protrusion 430 may be located in a first central portion 411 of the first mold 410 and/or a second central portion 421 of the second mold 420. At least a portion of the first central portion 411 and/or at least a portion of the second central portion 421 may face the central portion 311 of the main plate 310.

The protrusion 430 may be formed of a material having a specified range of stiffness and/or elasticity. For example, in an embodiment, the protrusion 430 may include polyurethane. In other embodiments, the protrusion 430 may be replaced with a polymer, or stainless steel. In an embodiment, protrusion 430 may be referred to as a punch or a urethane punch.

Structures, shapes, and/or the number of protrusions 430 may be selectively designed.

According to an embodiment (e.g., FIGS. 6A and 6B), the first mold 410 may include a first protrusion 431. The second mold 420 may not include the protrusion 430. The first protrusion 431 may be located at a center of the first mold 410. For example, the first protrusion 431 may apply pressure to the central portion 311 of the main plate 310 such that the central portion 311 protrudes.

According to an embodiment (e.g., FIGS. 7A and 7B), the first mold 410 may include a first protrusion 431, and the second mold 420 may include a second protrusion 432. According to an embodiment, the first protrusion 431 and the second protrusion 432 may be formed as a plurality of protrusions. At least a portion of the plurality of first protrusions 431 may be located in the first central portion 411 of the first mold 410, and at least a portion of the plurality of second protrusions 432 may be located in the second central portion 421 of the second mold 420. For example, the first protrusion 431 and the second protrusion 432 may provide pressure to the central portion 311 of the main plate 310 such that the central portion 311 protrudes. The numbers of protrusions 431 and 432 illustrated are illustrative, and the number, sizes, and/or patterns of the protrusions 431 and 432 may be selectively designed.

Shapes of the first mold 410 and/or the second mold 420 illustrated in FIGS. 6A, 6B, 7A, and 7B are illustrative. For example, sizes and shapes of the first mold 410 and/or the second mold 420 may be selectively designed to correspond to a shape of the case 300.

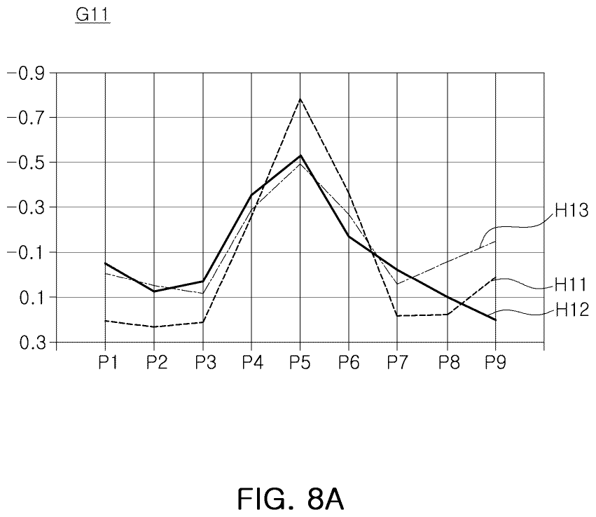

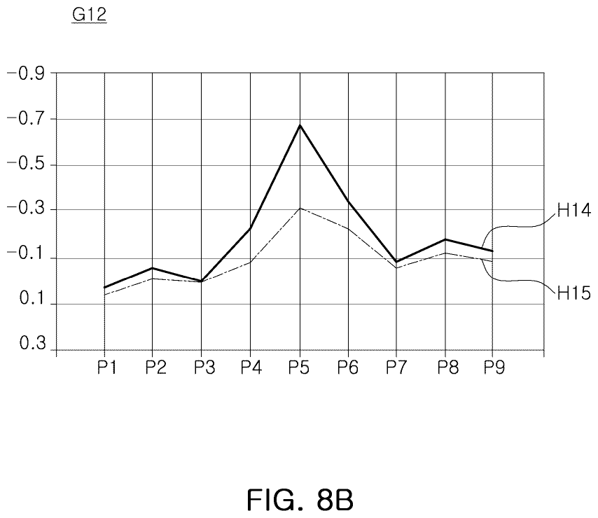

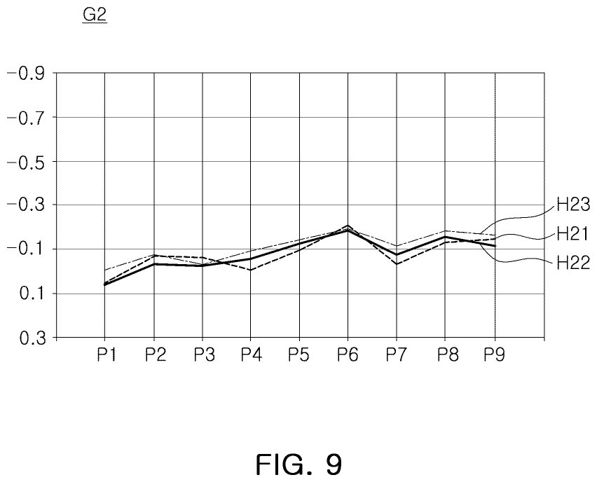

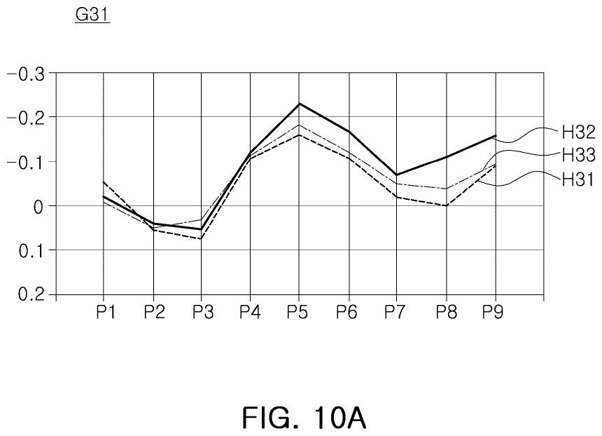

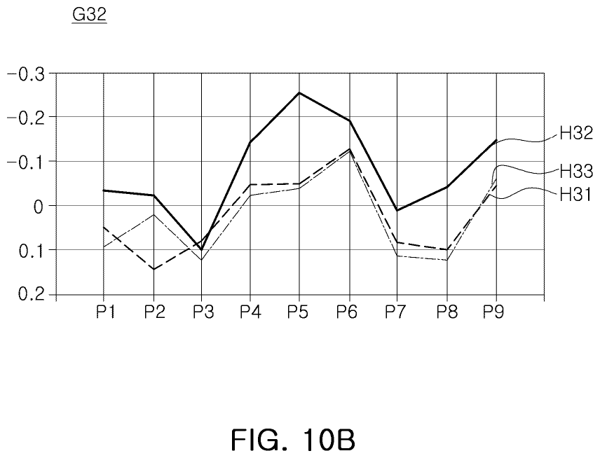

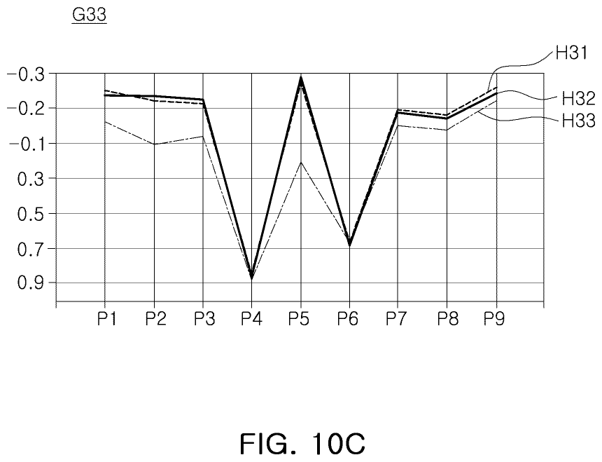

FIGS. 8A and 8B are graphs illustrating flatness of a case according to an embodiment. FIG. 9 is a graph illustrating flatness of a case according to a first comparative example. FIGS. 10A, 10B, and 10C are graphs illustrating flatness of a case according to a second comparative example.

In FIGS. 8A, 8B, 9, 10A, and 10B, a horizontal axis refers to each region of a plane of a main plate 310 (e.g., X-Y plane in FIG. 4), and a vertical axis refers to a height of a case 300 (e.g., position in the Z-axis direction of FIG. 3). A positive value for the height of the case 300 may refer to a degree of sagging in a gravity direction (e.g., downward direction toward an outside of a battery module 200), from a length measurement reference position. For example, a negative value on the vertical axis may refer to a length protruding in an upward direction, from a length measurement reference position of the case 300. As illustrated in FIGS. 8A, 8B, 9, 10A, and 10B, a height of the case 300 may be a value before the case 300 is assembled with a cell assembly 101.

A 1-1 graph G11 of FIG. 8A illustrates flatness of a case 300 manufactured using the pressing mold 400 of FIGS. 7A and 7B. For example, the 1-1 graph G11 of FIG. 8A illustrates flatness of a case 300 modified by a first mold 410 including a first protrusion 431 and a second mold 420 including a second protrusion 432. In the case 300 illustrated in FIG. 8A, 1-1 flatness H11, 1-2 flatness H12, and 1-3 flatness H13 may be values obtained by measuring profiles of surfaces of the case 300, respectively. In an embodiment, the values of the 1-1 flatness H11, the 1-2 flatness H12, and the 1-3 flatness H13 illustrate flatness adjusted by sizes, heights, shapes, and/or the number of protrusions 430 used. In an embodiment, the 1-1 flatness H11, the 1-2 flatness H12, and the 1-3 flatness H13 may be values obtained by measuring profiles of surfaces of the case 300 in different samples, respectively.

A 1-2 graph G12 of FIG. 8B illustrates flatness of a case 300 manufactured using the pressing mold 400 of FIGS. 6A and 6B. For example, the 1-2 graph G12 of FIG. 8B illustrates flatness of a case 300 modified by a first mold 410 including a first protrusion 431 and a second mold 420 not including a second protrusion 432.

In the case 300 illustrated in FIG. 8B, 1-4 flatness H14 and 1-5 flatness H15 may be values obtained by measuring profiles of surfaces of the case 300, respectively. According to an embodiment, the values of the 1-4 flatness H14 and the 1-5 flatness H15 illustrate flatness adjusted by sizes, heights, shapes, and/or the number of protrusions 430 used. According to an embodiment, the values of the 1-4 flatness H14 and the 1-5 flatness H15 may be values obtained by measuring profiles of surfaces of the case 300 in different samples, respectively.

Referring to FIGS. 8A and 8B, regions (e.g., fourth region P4, fifth region P5, and sixth region P6) located in a central portion 311 of the case 300 may protrude further in the first direction, as compared to regions (e.g., first region P1, second region P2, third region P3, seventh region P7, eighth region P8, and ninth region P9) located in an end region 312 of the case 300. For example, according to an embodiment (e.g., FIG. 8A), the central portion 311 (e.g., fifth region P5) of the case 300 may protrude further by about 0.65 mm at most in the first direction, than the fifth region P5 of the first comparative example. For example, according to an embodiment (e.g., FIG. 8B), the central portion 311 (e.g., fifth region P5) of the case 300 may protrude further at most by about 0.50 mm in the first direction, than the fifth region P5 of the first comparative example. As a difference in heights between the central portion 311 and the end region 312 increases, deformation (e.g., sagging) of the main plate 310 may be reduced.

A second graph G2 of FIG. 9 illustrates flatness of a case 300 manufactured without using a pressing mold 400. For example, the second graph G2 of FIG. 9 illustrates the flatness of the case 300 in which a second pressing process 12 is not performed after the first pressing process 11 of FIG. 5. In the case 300 illustrated in FIG. 9, 2-1 flatness H21, 2-2 flatness H22, and 2-3 flatness H23 may be values obtained by measuring profiles of surfaces of the case 300 in different samples, respectively. The values of the 2-1 flatness H21, the 2-2 flatness H22, and the 2-3 flatness H23 may illustrate flatness.

Referring to FIG. 9, regions (e.g., fourth region P4, fifth region P5, and sixth region P6) located in a central portion 311 of the case 300 may be formed to be substantially coplanar with regions (e.g., first region P1, second region P2, third region P3, seventh region P7, eighth region P8, and ninth region P9) located in an end region 312 of the case 300.

FIGS. 10A, 10B, and 10C illustrate flatness of a case 300 manufactured using a pressing mold 400 that does not include a protrusion 430. For example, a 3-1 graph G31, a 3-2 graph G32, and a 3-3 graph G33 in FIGS. 10A, 10B, and 10C illustrates flatness of a case 300 of which a central portion is deformed using a mold (e.g., core mold).

In the case 300 illustrated in FIGS. 10A, 10B, and 10C, 3-1 flatness H31, 3-2 flatness H32, and 3-3 flatness H33 may be values obtained by measuring profiles of surfaces of the case 300 in different samples, respectively. According to an embodiment (e.g., FIG. 10A), in the case 300, a central portion 311 of a main plate 310 deformed by a second pressing process by a first specified length (e.g., 3 mm) may protrude further at most by 0.1 mm, than an end region 312. According to an embodiment (e.g., FIG. 10B), in the case 300, a central portion 311 of a main plate 310 deformed by a second pressing process by a second specified length (e.g., 4 mm) may protrude further at most by 0.12 mm, than an end region 312. According to an embodiment (e.g., FIG. 10C), in the case 300, a central portion 311 of a main plate 310 deformed by a second pressing process by a third specified length (e.g., 5 mm) may protrude further at most by 0.13 mm, than an end region 312. The 3-1 flatness H31, the 3-2 flatness H32, and the 3-3 flatness H33 of the case 300 illustrated in FIGS. 10A, 10B, and 10C may be values obtained by measuring profiles of surfaces of the case 300 in different samples, respectively. The values of the 3-1 flatness H31, the 3-2 flatness H32, and the 3-3 flatness H33 may illustrate flatness.

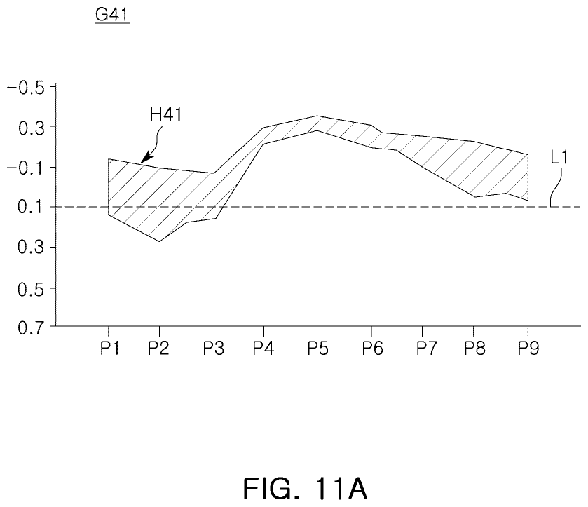

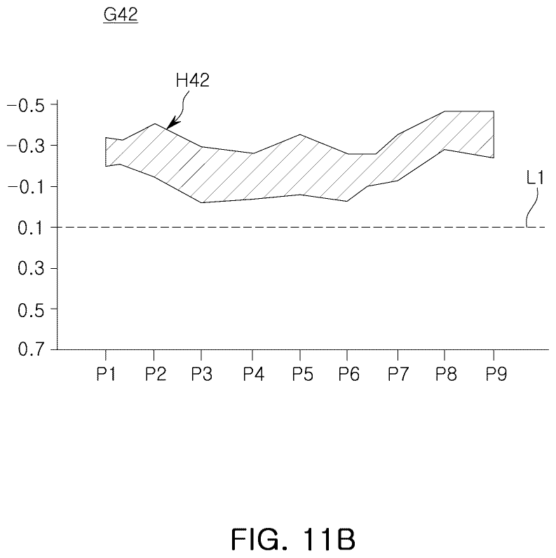

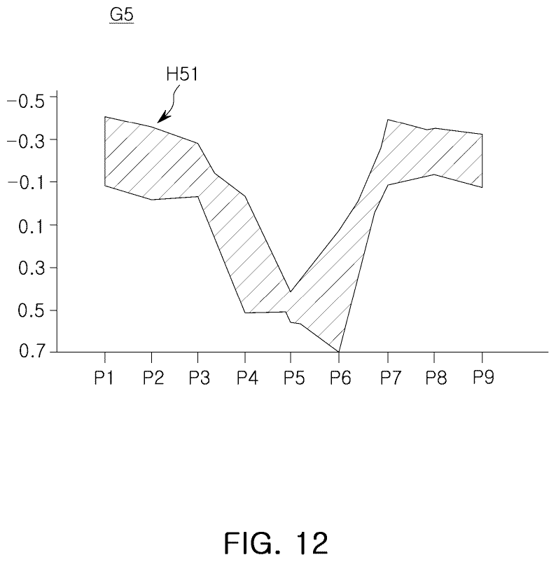

FIGS. 11A and 11B are graphs illustrating flatness of a case mounted on a battery module according to an embodiment. FIG. 12 is a graph illustrating flatness of a case mounted on a battery module according to a first comparative example.

Referring to FIGS. 11A, 11B, and 12 along with FIGS. 8A and 8B, flatness of a case 300 may be changed, when the case 300 is mounted on a battery module 200. For example, the case 300 may support a cell assembly 101, and a central portion 311 of a main plate 310 may sag due to load of the cell assembly 101. In FIGS. 11A, 11B, and 12, a horizontal axis refers to each region of a plane of the main plate 310 (e.g., X-Y plane in FIG. 4), and a vertical axis refers to a height of the case 300 (e.g., position in the Z-axis direction of FIG. 3). A positive value for the height of the case 300 may refer to a length sagging in a gravity direction (e.g., downward direction toward an outside of the battery module 200), from a length measurement reference position. For example, a negative value on the vertical axis may refer to a length protruding in an upward direction, from a length measurement reference position of the case 300.

A 4-1 graph G41 of FIG. 11A illustrates a flatness distribution area H41 of a case 300 manufactured using the pressing mold 400 of FIGS. 6A and 6B or the pressing mold 400 of FIGS. 7A and 7B. Referring to FIG. 11A, the case 300 before being assembled with a cell assembly 101 may have a flatness of −0.4 mm to 0.3 mm. For example, referring to FIG. 11A, in the flatness distribution area H41 of the case 300, a central portion (e.g., fourth region P4, fifth region P5, and sixth region P6) may be located in the first direction (e.g., +Z-direction in FIG. 4) by about 0.4 mm from a first reference line L1. In an embodiment, the first reference line L1 may be a position in the first direction of a fifth region P5 in a case in which the second pressing process 12 of FIG. 5 is not performed.

A 4-2 graph G42 of FIG. 11B illustrates a flatness distribution area H42 of a case 300 manufactured using the pressing mold 400 of FIGS. 6A and 6B or the pressing mold 400 of FIGS. 7A and 7B, in which the case 300 is connected to a cell assembly 101. Referring to FIG. 11B, the case 300 connected to the cell assembly 101 in an embodiment may have a flatness of-0.5 mm to 0 mm. For example, in a main plate 310, a difference between a height of a central portion 311 and a height of an end region 312 may be less than 0.5 mm. For example, referring to FIG. 11B, in the flatness distribution area H42 of the case 300, a central portion (e.g., fourth region P4, fifth region P5, and sixth region P6) and an end region (e.g., first region P1, second region P2, third region P3, seventh region P7, eighth region P8, and ninth region P9) may be located on a higher level than a first reference line L1 (e.g., in the first direction (+Z-direction) of FIG. 4).

In a state in which a case 300 is mounted on a cell assembly 101, the case 300 may be formed to be substantially flat. According to an embodiment, in a state in which a case 300 is mounted on a cell assembly 101, a central portion 311 of a main plate 310 (e.g., fourth region P4, fifth region P5, and sixth region P6) may be formed to be substantially coplanar with an end region 312 of the main plate 310 (e.g., first region P1, second region P2, third region P3, seventh region P7, eighth region P8, and ninth region P9). For example, a portion of the central portion 311 may protrude further in the first direction (+Z-direction), than at least a portion of the end region 312, or may be substantially coplanar with at least a portion of the end region 312. For example, at least a portion of the central portion 311 may be closer to the cell assembly 101 and/or a cover 230, than at least a portion of the end region 312. A lower portion of a battery module 200 (e.g., main plate 310 of the case 300) may be formed to be substantially flat, to reduce a defect rate of the battery module 200. Mass production yield and productivity of the battery module 200 may be improved.

According to an embodiment, when the case 300 is separated from the battery module 200, a shape of the case 300 may be deformed. The shape of the case 300 mounted on the battery module 200 of this document may be measured using non-destructive testing, in a state in which the case 300 is not separated from the battery module 200.

A fifth graph G5 of FIG. 12 illustrates a flatness distribution area H51 of a case, in a battery module including the case manufactured by a first comparative example (e.g., FIG. 9) in which the second pressing process of FIG. 5 is not performed. Referring to FIG. 12, the case connected to the cell assembly 101 of the first comparative example may have a flatness of −0.5 mm to 0.7 mm. In the first comparative example, a central portion of a case of an assembled battery module (e.g., fourth region P4, fifth region P5, and sixth region P6) may be located on a lower level in the battery module than an end region (e.g., first region P1, second region P2, third region P3, seventh region P7, eighth region P8, and ninth region P9). For example, deformation due to load may occur in the battery module of the first comparative example.

FIG. 13 is an exploded perspective view of a battery pack according to an embodiment.

Referring to FIG. 13, a battery pack 500 may include at least one battery module 200 and a pack frame 510 accommodating the at least one battery module 200. The description of the battery module 200 described in FIGS. 2 and 3 may be applied to the battery module 200 in FIG. 13.

The pack frame 510 may accommodate a component of the battery pack 500 (e.g., battery module 200). The pack frame 510 may include a bottom member 511 supporting the battery module 200, a pack cover 512 covering the battery module 200, and a pack side wall 513 connecting the bottom member 511 and the pack cover 512. The bottom member 511 may support a main plate (e.g., main plate 310 of FIG. 3) of a case (e.g., case 300 of FIG. 3) of the battery module 200.

The pack frame 510 may include a partition wall 514 crossing at least a portion of a plurality of battery modules 200. For example, an accommodation space of the pack frame 510 may be divided into a plurality of spaces by the partition wall 514. The partition wall 514 may be installed to cross the accommodation space to reinforce rigidity of the pack frame 510. In an embodiment, at least a portion of the plurality of partition walls 514 may include a venting hole for guiding a path of gas and/or flame generated in the battery module 200.

In an embodiment, the battery pack 500 may include a duct member 560. A flow space in which gas and/or flame discharged from the battery module 200 flows may be formed in the duct member 560. The duct member 560 may be disposed in the pack frame 510. The flow space of the duct member 560 may be connected to the venting hole of the partition wall 514. For example, gas and/or flame generated from a battery cell of the battery module 200 (e.g., battery cell 100 in FIG. 1) may be delivered to an outside of the battery pack 500 through the venting hole formed in the partition wall 514 and the flow space of the duct member 560.

The battery pack 500 may include a battery control unit 590 to control the battery module 200. The battery control unit 590 may be disposed in the pack frame 510. The battery control unit 590 may include a battery management system (BMS). Since a configuration of the battery control unit 590 may be known in various forms, detailed description thereof will be omitted. In an embodiment, the battery control unit 590 may be referred to as a processor.

The contents described above may be merely an example of applying the principles of the disclosure of this patent document, and other configurations may be further included without departing from the scope of the disclosure of this patent document.

According to an embodiment of the disclosure of this patent document, sagging of a battery module in a downward direction may be prevented or reduced.

According to an embodiment of the disclosure of this patent document, defects in a battery module may be reduced. According to an embodiment of the disclosure of this patent document, mass production yield and productivity of a battery module may be improved.

Only specific examples of implementations of certain embodiments may be described. Variations, improvements and enhancements of the disclosed embodiments and other embodiments may be made based on the disclosure of this patent document.

What is claimed is:

1. A battery module comprising:
a cell assembly including a plurality of battery cells; and
a case including a main plate supporting the cell assembly and a side wall facing the cell assembly,
wherein the main plate includes a central portion and an end region extending from the central portion,
at least a portion of the central portion protrudes further toward the cell assembly, than at least a portion of the end region, or is coplanar with the at least a portion of the end region.

2. The battery module of claim 1, wherein, before the case is assembled with the cell assembly, the central portion is formed to protrude further than the end region toward the cell assembly.

3. The battery module of claim 1, wherein a difference in heights between the central portion and the end region is within 0.5 mm.

4. The battery module of claim 1, wherein the case comprises stainless steel or aluminum.

5. The battery module of claim 1, further comprising:
a busbar assembly including a busbar connected to electrode tabs of the plurality of battery cells, and a busbar frame supporting the busbar;
a cover disposed on one side of the cell assembly and connected to the side wall;
an end plate connected to the case and surrounding at least a portion of the cell assembly; and
an insulating cover located on at least a portion of the busbar assembly and the side wall.

6. A case comprising:
a main plate configured to support a cell assembly; and
a side wall extending from the main plate in a first direction,
wherein the main plate includes a central portion and an end region extending from the central portion, and
the central portion is formed to protrude further than the end region in the first direction.

7. The case of claim 6, wherein a height of the central portion is more than or less than a height of the end region by 0.1 mm to 0.7 mm.

8. The case of claim 6, comprising at least one of stainless steel or aluminum.

9. A method for manufacturing a battery case, comprising:
a first pressing process of forming a case including a main plate and a side wall extending from the main plate in a first direction; and
a second pressing process of pressing a central portion of the main plate using a pressing mold including a protrusion.

10. The method of claim 9, wherein the pressing mold comprises a first mold including a first protrusion configured to contact the central portion, and a second mold configured to be located in an opposite direction of the first mold, based on the main plate.

11. The method of claim 10, wherein the second mold comprises a second protrusion configured to contact the central portion.

12. The method of claim 11, wherein the first protrusion provides an external force to a first surface of the main plate, and
the second protrusion provides an external force to a second surface of the main plate, opposite to the first surface.

13. The method of claim 9, wherein the protrusion comprises polyurethane.

14. The method of claim 9, wherein the case comprises a side wall extending from the main plate in the first direction, and
the main plate comprises an end region extending from the central portion,
wherein the second pressing process is configured to deform the main plate such that a height of the central portion protrudes further in the first direction, than a height of the end region.

15. The method of claim 14, wherein the height of the central portion deformed by the second pressing process in the first direction is more than or less than the height of the end region by 0.1 mm to 0.7 mm.
